(19) United States
(12) Patent Application Publication
(10) Pub. No.: US 2011/0270864 A1
(43) Pub. Date: Nov. 3, 2011

(54) COMPARISONS BETWEEN ENTITIES OF A PARTICULAR TYPE

(75) Inventors: Vijay Mital, Kirkland, WA (US); Saurab Nog, Sammamish, WA (US); Jason A. Wolf, Kirkland, WA (US); John A. Payne, Seattle, WA (US)

(73) Assignee: Microsoft Corporation, Redmond, WA (US)

(21) Appl. No.: 12/770,272

(22) Filed: Apr. 29, 2010

(51) Int. Cl. G06F 17/30

(52) U.S. Cl. 707/767; 707/E17.109

(57) ABSTRACT

Embodiments of the invention provide techniques for increasing the efficiency and effectiveness with which entities or entities may be compared and contrasted across one or more dimensions. Some embodiments present on a user interface (UI) a small, visually navigable collection of entities, from which the user may select a “focus” entity that may then be compared with other entities of interest. The UI may employ a visual organization scheme that organizes information on entities according to one or more dimensions, which may be predefined and/or configurable. Embodiments may facilitate rapid cognition of the manner in which information is presented and organized, and enable a user to quickly and easily discern dissimilarities and/or similarities between the focus entity and one or more other selected entities.

### BACKGROUND

The widespread availability of computer networks has enabled users of devices that connect to networks (e.g., computers, mobile phones, personal digital assistants, content reproduction devices, etc.) to access vast quantities of information. For example, a user of a device may access any of numerous sources of information via networks such as the Internet, thereby gaining access to information on any number of things, such as products, services, events, people (e.g., other users), etc. A user may access information for personal reasons, business reasons, etc.

One conventional approach employed by users to gain access to information via a network is by using a search engine. Typically, a search engine functions by generating an index of items accessible over one or more networks in advance of a user's submitting a request to locate information. Each item may, for example, comprise a web page, one or more files including information, and/or other forms of information. When the search engine receives a user's request for information (e.g., a search query) about a particular topic, the search engine may select one or more items for presentation to the user by matching terms in the search query to items in the index. Items which match the search query may then be displayed to the user.

Users often wish to compare multiple items of information returned in response to a search query. For example, a user seeking to buy a particular type of product may use a search engine to search for products of that type, and then compare the characteristics of each product to select a particular product for purchase, or narrow the list to a subset of candidates for purchase.

### SUMMARY

Applicant has appreciated that conventional approaches to enabling a user to compare and contrast characteristics of entities (e.g., items, products, services, people and/or other entities) of interest are unnecessarily laborious for the user. For example, in the e-commerce context, conventional approaches employed by a user often involve submitting a query for products of a particular type to a search engine, such as one provided by a search web site, e-commerce web site, etc. One or more filters may be applied to the query and/or results so that the number of products presented to the user in response to the query is of manageable size for the user and so that the user is not overwhelmed by the amount of information returned. The user may then spend considerable time narrowing down the products presented to identify a subset that are candidates for purchase. To do so, the user usually must specify one or more bases for comparing the products, such as product attributes and/or other information, to identify the subset of products. As an example, a user seeking information on digital SLR cameras may initiate a comparison based on product attributes like price, brand name, shutter speed, etc., to determine a group of candidates for purchase. The user may then perform an even more detailed comparison between two or more products of the candidates to select one for purchase, again by specifying the basis for comparing the products. For example, some conventional e-commerce sites allow a user to identify products to be compared (e.g., by clicking a check box for each product to be compared), and to then request that detailed information (e.g., the values for each specified attribute) on those products be displayed (e.g., in grid or table form). If after reviewing the information displayed the user determines that the comparison should not include a product previously selected (e.g., because the user eliminates that product from consideration), then the user is typically required to “un-flag” that product and request information on only remaining “flagged” products. If the user determines that the comparison should include additional or different products, he/she typically must return to the previous page and re-submit a request with the appropriate products being “flagged,” and then repeat the exercise of comparing product attributes until the user arrives at a particular product that he/she wishes to purchase. This process is unnecessarily laborious for the user.

Some embodiments of the invention provide techniques for increasing the efficiency and effectiveness with which a list of entities may be narrowed down to manageable proportions, and with which one or more entities may be compared and contrasted across one or more dimensions. For example, some embodiments of the invention provide techniques for presenting entities returned in response to a search query in the form of a small, visually navigable collection (e.g., list), from which the user may select a “focus entity” that may then be compared with other entities of interest. A user interface (UI) may be provided which employs a visual organization scheme so that information on entities is organized according to one or more dimensions, which may be predefined and/or configurable. Employing this visual organization scheme may facilitate rapid recognition by the user of the manner in which information is presented and organized, and enable the user to navigate information organized along each dimension to select any one or more entities for comparison and contrast with the focus entity. In some embodiments, the user's selection of a focus entity may result in the display of a new collection of entities that are similar in some ways and dissimilar in other ways to the selected focus entity. The user may then select one or more entities for comparison and contrast with the focus entity, which may cause information defining dissimilarities and/or similarities between the focus entity and selected other entity(ies) to be dynamically displayed. As a result, the user may more quickly and efficiently identify entities of particular interest in a given context and discern dissimilarities and/or similarities between those entities. As a result, embodiments of the invention may enable quicker and better decision-making with respect to actions taken on those entities.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a representation of an example user interface (UI) displaying information on entities of interest to a user, implemented in accordance with some embodiments of the invention;

FIG. 2 is a representation of an example UI displaying information enabling comparison and contrast among certain entities of interest to a user, in accordance with some embodiments of the invention;

FIG. 3 is a representation of an example UI displaying information, on entities of interest to a user, organized across dimensions, in accordance with some embodiments of the invention;

FIG. 4 is a representation of an example UI displaying information enabling comparison and contrast among entities of interest to a user, in accordance with some embodiments of the invention;

FIG. 5 is a representation of an example UI displaying information enabling decision-making respecting actions taken on entities of interest to a user, in accordance with some embodiments of the invention;

FIG. 6 is a flowchart depicting an example process which may be performed to enable comparisons between a focus entity and one or more other entities, in accordance with some embodiments of the invention;

FIG. 7 is a block diagram depicting an example computer system on which some embodiments of the invention may be implemented; and

FIG. 8 is a block diagram depicting an example memory on which instructions embodying aspects of the present invention may be stored.

### DETAILED DESCRIPTION

Some embodiments of the invention provide techniques which enable a user to quickly and efficiently compare and contrast attributes of entities of interest to the user, and thereby discern similarities and/or dissimilarities between the entities, enabling more effective decision-making with respect to the entities. For example, some embodiments of the invention provide a UI which enables a user to select one of the entities of interest as a focus entity, and presents information on other entities of interest so that the information is organized along one or more dimensions. Each dimension may, for example, represent an attribute that is shared by the entities, with the information being organized according to each entity's value for the attribute. For example, embodiments of the invention employed in an e-commerce context may present information on products of interest to the user so that information is organized along dimensions corresponding to attributes such as price, brand name user ratings, etc., with each product being displayed on the dimension according to the product's value for the attribute. Such organization along dimensions may enable the user to quickly discern the product(s) to which he/she wishes to compare the focus product. In some embodiments, selecting one or more product to which a focus product is to be compared causes information defining dissimilarities between the focus product and other products to be displayed, so that the user may quickly and easily discern these dissimilarities without having to manually search for the attributes defining the dissimilarities and request that a comparison based on these attributes be performed. For example, attributes for which the other products have values different than the focus product may be displayed. As a result, the user may compare and contrast entities of interest more easily than conventional approaches allow, and make more effective decisions with regard to actions taken with respect to those entities.

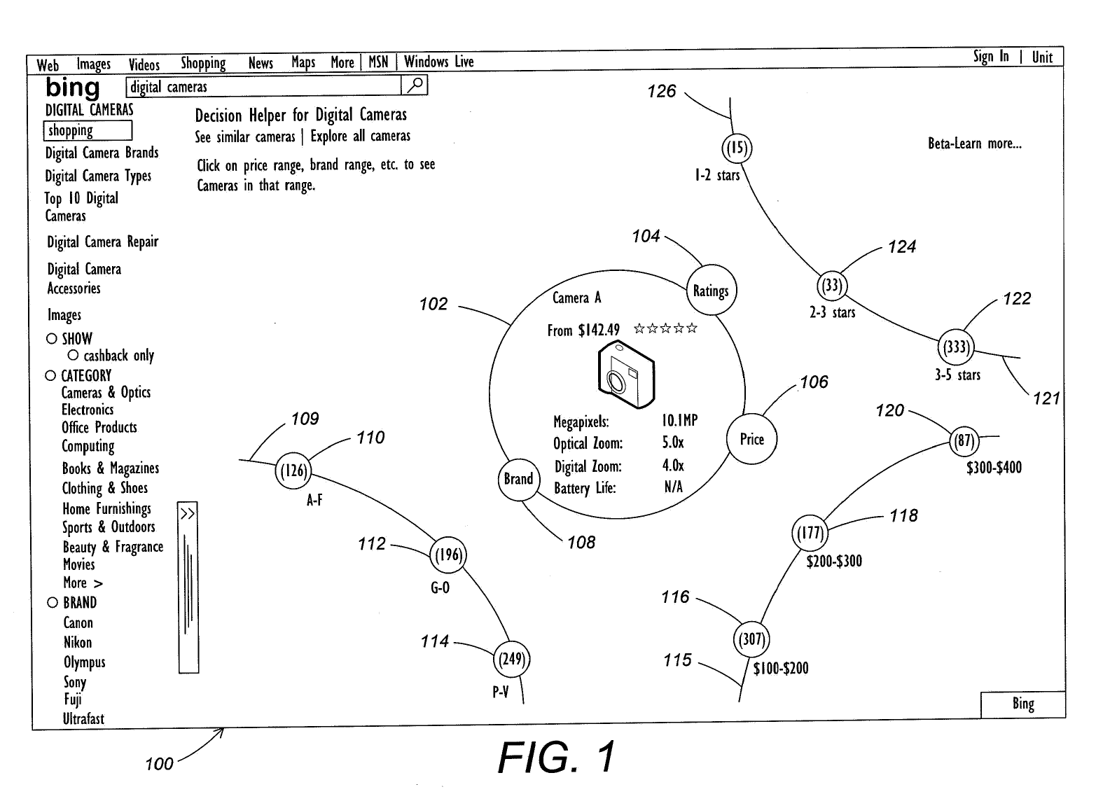

Example user interfaces implemented in accordance with some embodiments of the invention are depicted in FIGS. 1-4. The examples shown relate to a user's search for information on digital cameras, such as for the purpose of selecting a particular digital camera for purchase. However, it should be appreciated that embodiments of the invention are not limited to being employed in an e-commerce context, and may enable improved decision-making in any of numerous contexts, as is discussed below. When employed in an e-commerce context, embodiments of the invention need not present information on digital cameras, or on any other particular product(s), as the techniques described herein are equally applicable to discerning similarities and/or dissimilarities among any one or more entities, including products, services, people, articles, etc.

In the example UI 100 shown in FIG. 1, a user has selected camera A as a focus entity 102, to serve as a basis for comparison and contrast with one or more other entities. As a result of the selection of camera A as the focus entity, other entities are laid out in groups along multiple dimensions. The other entities selected for displayed may be chosen in any of numerous ways. For example, in some embodiments, the user's selection of a focus entity may cause the selection of other entities for display. The other entities may be similar in some ways (e.g., possess similar attributes and/or be similar in some other fashion) and dissimilar in other ways (e.g., possess dissimilar attributes and/or be dissimilar in some other fashion) to the focus entity. Similarity and dissimilarity to the focus entity may, for example, be defined by attributes defining the dimensions shown in example UI 100, be different attributes, and/or be some combination and/or derivation thereof. Embodiments of the invention are not limited in this respect.

In the example UI 100, dimensions are depicted as arcs 109, 115 and 121, representing brand, price and ratings dimensions, respectively, as indicated via icons 108, 106, and 104. In some embodiments, the dimensions displayed are predefined (e.g., established in a model to be used with searches for the type of entity shown). However, embodiments of the invention are not limited in this respect, as dimensions may be defined using any suitable technique, including dynamically (e.g., based on user behavior, observed user preferences, etc.).

It should be appreciated that although three dimensions are depicted in the example UI shown, any number of dimensions may be displayed, as embodiments of the invention are not limited in this respect. For example, a UI implemented in accordance with embodiments of the invention may enable a user to select one or more other or additional dimensions for display, hide any dimension(s) displayed, etc. Further, each dimension may represent any one or more attributes of entities of interest, a derivation thereof, or other information. Embodiments of the invention are not limited with respect to the information represented and the manner in which that information is organized.

In the example UI 100 shown, information on entities related to focus entity 102 is arranged in an ordered sequence along each of the dimensions represented by arcs 109, 115 and 121. For example, along the brand dimension represented via arc 109, are arranged by brand name in alphabetical order, with the entities being organized into three groups, represented by icons 110, 112 and 114, being displayed. In the example UI depicted, entities having brand names beginning with the letters A-F are represented by icon 110, entities having brand names beginning with the letters G-O are represented by icon 112, and entities having brand names beginning with the letters P-V are represented by icon 114. It should be appreciated that organizing information on entities related to focus entity 102 facilitates rapid user recognition of the manner in which the information is organized and may be accessed. However, it should also be appreciated that embodiments of the invention are not limited to organizing information on entities alphabetically by brand name, to grouping entities by brand name, or to displaying groups at all. Embodiments of the invention are not limited to using any particular scheme to organize information displayed.

In some embodiments of the invention, a user of the example UI shown may access a display of entities having particular brand names by “hovering over” or otherwise providing input to any of icons 110, 112, or 114. Doing so may cause one or more entities to be revealed, which may then be selected for comparison and contrast to focus entity 102. For example, a user of UI 100 may hover over icon 112 to cause entities having brand names beginning with the letters G-O to be revealed. The user may then select one or more of the entities revealed for comparison with the focus entity.

In the example UI 100 shown, along the price dimension represented by arc 115, entities are arranged in sequence according to price, with three groups, represented by icons 116, 118 and 120, being displayed. In the example UI depicted, entities having prices between $100-200 are represented by icon 116, entities having prices between $200-300 are represented by icon 118, and entities having prices between $300-400 are represented by icon 120. To cause entities in a particular price range to be revealed that may be selected for comparison with the focus entity, the user may hover over or otherwise provide input to any of icons 116, 118 or 120. For example, the user may hover over icon 118 to cause entities having prices between $200-300 to be revealed, and the user may then select one or more of the entities revealed for comparison with the focus entity.

Along the ratings dimension represented by arc 121, entities are arranged in sequence according to user rating, with three groups, represented by icons 122, 124 and 126, being displayed. In the example UI 100 depicted, entities having ratings between one and two “stars” are represented by icon 126, entities having ratings between two and three stars are represented by icon 124, and entities having ratings between three and five stars are represented by icon 122. To cause entities in a particular rating range to be revealed that may be selected for comparison with the focus entity, the user may hover or otherwise provide input to over any of icons 122, 124 or 126. For example, the user may hover over icon 124 to cause entities rated between two and three stars to be revealed, and the user may then select one or more of the entities revealed for comparison with the focus entity.

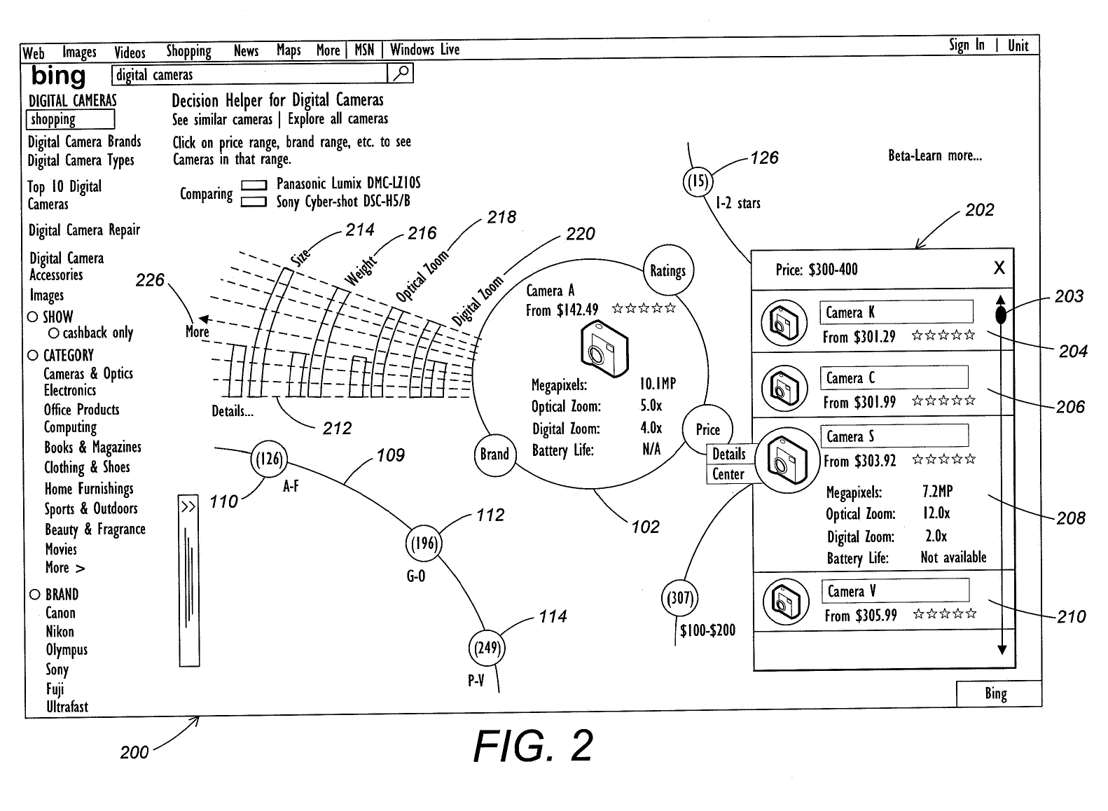

FIG. 2 depicts an example UI 200 which may be displayed when the user hovers over or otherwise provides input to icon 120, causing entities in the $300-400 price range to be revealed in box 202 so that one or more of the entities may be selected for comparison with the focus entity. In the example shown, box 202 presents information on various entities in this price range in list form. For example, information on entity B is presented as list item 204, information on entity C is presented as list item 206, information on entity D is shown as list item 208, and information on list item E is shown as list item 210. A user may scroll among the list entities displayed using control 203.

In the example UI shown, a user may cause additional information on a particular list item to be displayed by hovering over or otherwise providing input to the list item. For example, it can be seen that each of list entities 204, 206, and 210 includes an indication of the corresponding entity's price and user rating. However, by hovering over list item 208, the user has also caused information on the entity D′s megapixels, optical zoom, digital zoom and battery life to be shown.

In the example UI shown, hovering over or otherwise providing input to list item 208 also causes an indication of dissimilarities between the focus entity and the selected entity to be shown. In the example UI 200, hovering over list item 208 has caused chart 212 to be presented, which in this example is a bar chart in which certain attributes of focus entity 102 and entity D are represented, so that different manifestations of those attributes by each entity can be seen. In some embodiments of the invention, the attributes that are chosen for display are those which allow the user to quickly and easily identify the dissimilarities between focus entity 102 and entity D.

Any suitable technique may be employed to determine the attribute(s) that are chosen for display to the user. For example, in some embodiments, one or more dissimilarity algorithms (e.g., implemented as programmed instructions for execution on at least one processor of a computer and/or other device(s)) may be executed to determine the attributes. The dissimilarity algorithm(s) may, as an example, choose one or more attributes for display from a previously defined set of attributes designated for this purpose, choose attributes in which dissimilarities between the entities selected for comparison are manifested (e.g., attributes for which the entities selected for comparison have values different than the focus entity), choose attributes which the user's previous behavior indicates are important to the user, a combination thereof, or using some other manner of selecting attributes for display. The attributes chosen for display may or may not include those reflected in any dimension represented by arcs 109, 115 and 121, and/or may reflect a value calculated from one or more other attributes. Any suitable one or more techniques may be employed to determine the attributes chosen for display to the user, as the invention is not limited to any particular implementation.

In the example UI shown, the attributes chosen for display are those in which dissimilarities between the entities selected for comparison are manifested. In chart 212, column 214 includes bars representing the respective sizes of the focus entity and entity D, column 216 includes bars representing the respective weights of the focus entity and entity D, column 218 includes bars indicating the respective optical zooms of the focus entity and entity D, and column 220 includes bars indicating the respective digital zooms of the focus entity and entity D.

It should be appreciated that the information presented in chart 212 enables the user to quickly and easily determine dissimilarities between the focus entity and one or more other entities selected for comparison. Further, this information is presented in a manner which facilitates rapid cognition by the user of those dissimilarities. To determine the dissimilarities between a set of (e.g., two) entities, the user need not first flag the set to be compared, request a table or chart of the entities' attributes to be displayed, narrow the list of entities based on the information displayed, etc. Instead, embodiments of the invention organize information on entities to a visually manageable and cognizable proportion, and provide the capability to create comparison sets (e.g., pairs) dynamically within the UI to facilitate easy comparison and contrast between entities. The user can rapidly navigate amongst a body of entities to determine an appropriate action to be taken with respect to any of the entities, based on their respective attributes.

In the example UIs shown in FIGS. 1-2, the entities grouped along the dimensions represented by arcs 109, 115 and 121 include a large population of entities to which the focus entity 102 can be compared. In some embodiments of the invention, a subset may be displayed instead of the entire population, so that the user is presented with information on a smaller, more manageable population. In some embodiments, this subset is selected via execution of a partial-similarity algorithm designed to identify entities that are sufficiently similar in at least one respect to the focus entity. For example, when a user selects a particular entity as the focus entity, the partial-similarity algorithm may be executed to identify the subset of entities that are at least partially similar to the selected focus entity. These “best match” entities may be displayed along one or more dimensions, as in FIGS. 1-2. The dimensions along which the entities are organized may or may not be employed by the partial-similarity algorithm to determine the best matches for the focus entity.

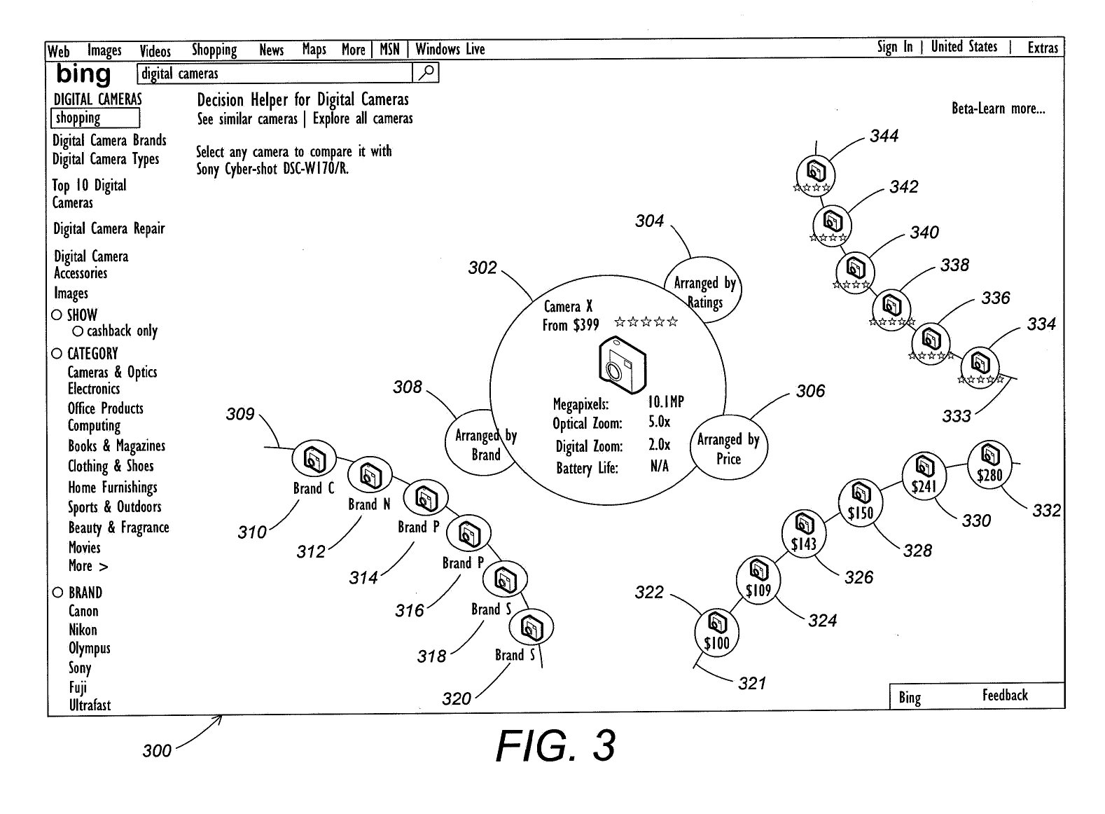

FIG. 3 depicts an example UI 300 which displays information on entities determined to be the best matches for a focus entity selected by the user. In FIG. 3, information is presented on entities determined to represent best matches for focus entity 302. This information is presented along three dimensions, including the ratings dimension indicated by icon 304, the price dimension indicated by icon 306, and the brand dimension indicated by icon 308. For example, providing input (e.g., hovering over) to any of icons 310, 312, 314, 316, 318 or 320 allows the user to view information on specific camera brands, providing input to any of icons 322, 324, 326, 328, 330 or 332 allows the user to view information on cameras at specific price points, and providing input to any of icons 334, 336, 338, 340, 342 or 344 allows the user to view information on cameras having specific ratings. As with the UIs described above with reference to FIGS. 1-2, the user may quickly navigate amongst the entities for which information is displayed and discern dissimilarities between the focus entity and any one or more other entities for which information is displayed, except that the population among which such comparisons are possible is a smaller, more manageable one.

As an example, a user of UI 300 who sees that the focus entity has a rating of four “stars” may wish to determine dissimilarities between the focus entity and other entities with a rating equal to or higher then the focus entity. To cause entities which also have a four-star rating to be displayed, the user may hover over or otherwise provide input to icon 340. Once these entities are displayed, the user may hover over or otherwise provide input to any one or more of the entities displayed, as is described above with reference to FIGS. 1-2, to determine dissimilarities between the focus entity and the other entity(ies). This capability may be of great value, as it may enable the user to quickly evaluate the focus entity in the context of one or more of its peers. For example, by causing other entities having four star ratings to be revealed, the user may be able to quickly determine whether the price of the focus entity (as an example attribute) is comparable to the price of the other four-star entities revealed, thus enabling the user to assess whether the focus entity is a good value as compared to its four-star peers. Further, the user may initiate a detailed comparison between the focus entity and one or more of those peers, so that dissimilarities between the focus entity and the other selected entity(ies) may be revealed. For example, the user may choose another four-star entity that is priced higher than the focus entity for comparison with the focus entity, and quickly determine whether or not it has features that the focus entity does not that cause it to be priced higher. If so, the user may evaluate whether those extra features justify the extra money, etc. Any of numerous comparisons of this ilk may be performed, as embodiments of the invention are not limited in this respect.

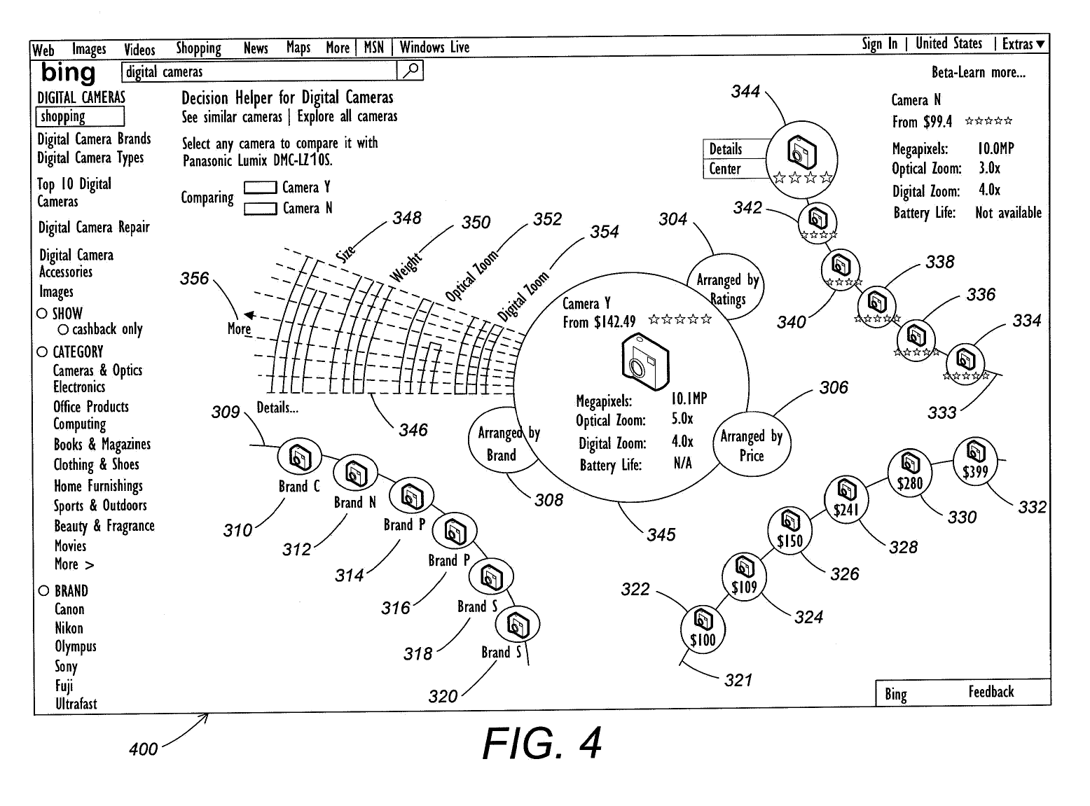

FIG. 4 depicts example UI 400 in which a user has initiated a detailed comparison between entities. UI 400 displays much of the same information as is shown in FIG. 3, including icons 310-320, 322-332 and 334-344, which allow the user to view information on cameras having specific brand names, prices, and ratings, respectively. In the example shown, the user has initiated a comparison between focus entity 345 the entity represented by icon 344. As a result of this, information on focus entity 345 and the other entity selected is presented in chart 346. As with chart 212 described above with reference to FIG. 2, chart 346 is a bar chart, although embodiments of the invention are not limited to displaying information on entities in this or any other form, as any suitable manner of presentation may be employed.

As described above, any suitable technique may be employed to determine which attributes are displayed in chart 346. For example, one or more dissimilarity algorithms may be executed to choose attributes in which the widest variations between the selected entities are exhibited, and/or using some other manner of selecting information for display. Any suitable technique may be employed, as embodiments of the invention are not limited in this respect.

As a result of information being displayed in chart 346, the user may quickly discern dissimilarities and/or similarities between the entities selected for comparison. In the example shown, it can be seen that the size of the entities (as represented by the bars in column 348) and optical zoom (as represented by the bars in column 352) are different, but the weight (as represented by the bars in column 350) and digital zoom (as represented by the bars in column 354) are roughly the same. Using control 356, the user may cause additional and/or different attributes to be displayed. By presenting this information in this manner, the UI allows the user to quickly and easily determine similarities and dissimilarities between the two entities selected for comparison. Further, depending on the user's needs and/or intended use for the camera, he/she may assign great value to some attributes and less value to others, and the UI may allow the user to quickly determine how the entities selected compare with respect to those attributes valued by the user more highly than others.

It should be appreciated that although FIG. 4 depicts an example comparison between two entities (i.e., focus entity 345 and the entity represented by icon 344), embodiments of the invention may enable any number of entities to be compared and contrasted, as the invention is not limited in this respect. Further, the attributes that serve as the basis for a comparison and/or contrast are not limited to those shown in the example UI of FIG. 4, as any information relating to the entities selected for comparison may be displayed, in any form. Embodiments of the invention are not limited in this respect.

Some embodiments of the invention may enable a user to filter information displayed along one dimension by selecting an attribute represented on another dimension. Using the example UI 400 shown in FIG. 4 to illustrate, a user may select a range of prices represented along arc 321, and have only the entities that fall into the selected price range be the entities for information is represented along the brand dimension represented by arc 309, and rating dimension represented by arc 333. For example, a user may hover over or otherwise provide input to icons 324, 326, 328 and 330 to select entities in the price range $109-280, and thereby cause information on only those entities in that price range to be shown along the dimensions represented by arcs 309 and 333. This may be of considerable value to a user in selecting a product for purchase. For example, if the selected price range is the user's budget for a product, the user can quickly and easily eliminate from the display products that are outside his/her budget, and be able to quickly see what brands and user ratings are represented among the entities in the selected price range. As a result, the user can quickly and easily narrow down a population of candidate entities to a visually manageable and navigable subset.

As noted above, embodiments of the invention are not limited to being employed in the e-commerce context, and may be employed in any context in which a capability to quickly and easily discern similarities and dissimilarities between entities of interest is valuable. As an example alternative to the e-commerce context, embodiments of the invention may be employed in the healthcare context. For example, embodiments of the invention may enable a caregiver to quickly determine similarities and dissimilarities between a focus patient (e.g., one for which a particular treatment regimen is contemplated) and one or more other patients (e.g., which may be similar in some respects to the focus patient). By providing a capability to quickly identify and assess similarities and dissimilarities between the focus patient and various cohorts, embodiments of the invention may enable the caregiver to determine, as an example, whether the treatment regimen contemplated for the focus patient produced favorable outcomes amongst cohorts having similarities along one or more dimensions, such as cohort attributes (e.g., gender, age, socioeconomic status, etc.), treatment circumstances (e.g., medications, admission dates, chief complaint, discharge time, insurance, etc.), and/or other similarities.

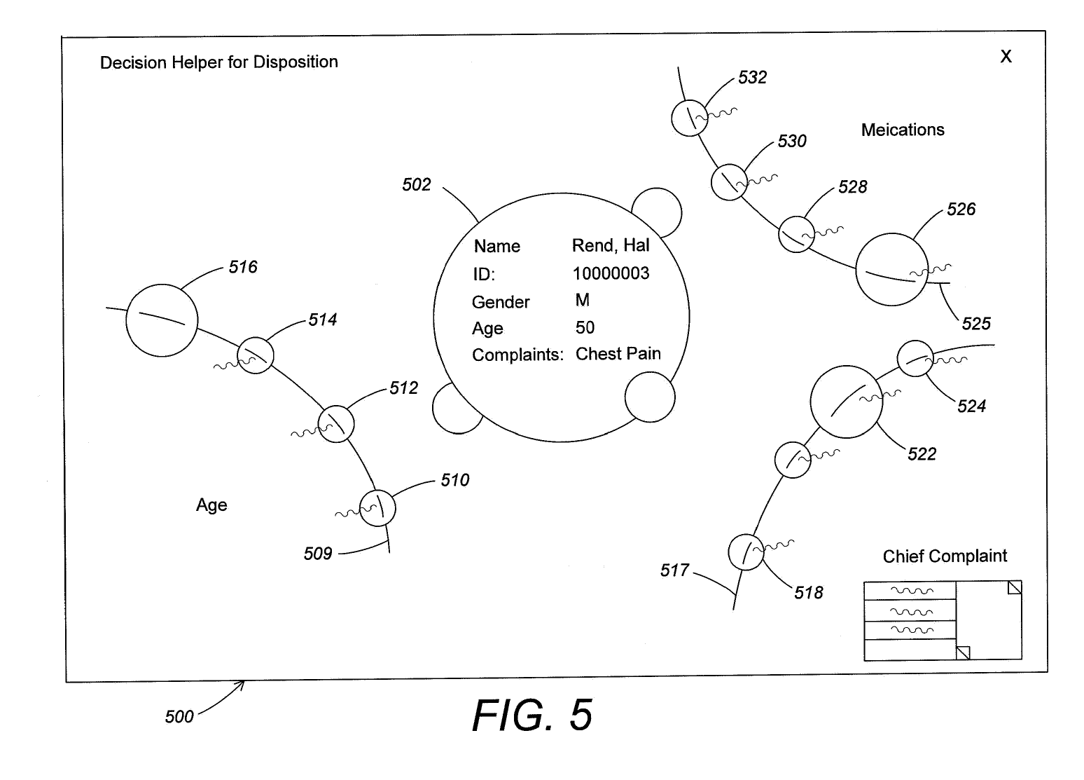

An example UI 500 with which a user may compare and contrast entities of interest in the healthcare context along one or more dimensions is depicted in FIG. 5. In the example shown, a user has selected focus patient 502 (in the example shown, “Hal Rend”). Information on cohorts of focus patient 502 are displayed along the age dimension represented by arc 509, chief complaint dimension represented by arc 517, and medication dimension represented by arc 532. The cohorts for which information is displayed along the dimensions shown may or may not have been identified via execution of one or more partial-similarity algorithms, as described above with reference to FIG. 3, which may or may not employ any of the dimensions represented by arcs 509, 517 or 532 to identify the cohorts for which information is displayed.

As with the example UIs described above with reference to FIGS. 1-4, example UI 500 may enable the user to quickly and easily identify similarities and/or dissimilarities between the focus patient 502 and one or more cohorts for which information is displayed along one of the dimensions shown. For example, the user may hover over or otherwise provide input to any of icons 518, 520, 522 or 524 to cause information on cohorts having chief complaints represented by these icons to be displayed. For example, assume that icon 520 represents one or more cohorts having the same chief complaint as Hal Rend. By hovering over or otherwise providing input to icon 520, the user may cause information on these one or more cohorts to be revealed, and may select one or more of the cohorts for a detailed comparison with Hal Rend, so that information (e.g., similar to charts 212 and/or 346) identifying similarities and/or dissimilarities between Hal Rend and the selected cohort(s) is displayed. Doing so may enable the user to quickly and easily discern similarities and/or dissimilarities between Hal Rend and cohorts experiencing the same chief complaint, such as similarities and/or dissimilarities in medications administered, age, gender, admission or discharge time, etc.). As time is often of the essence in evaluating treatment options for patients, the capability to quickly and easily evaluate and assess a patient in the context of his/her peers, rather than having to manually select individual patients for comparison and then identify the attributes that should serve as the basis for the comparison, may be of considerable value. Embodiments of the invention may thus improve the efficiency and effectiveness with which users make decisions with respect to entities of interest.

It should be appreciated that although described herein only in relation to the e-commerce and healthcare contexts, embodiments of the invention may be employed in any of numerous contexts. In this respect, embodiments of the invention may be employed in any one or more contexts in which being able to more efficiently compare and contrast entities of interest, and make improved decisions with respect to those entities, is of value. Embodiments of the invention are not limited to any particular implementation.

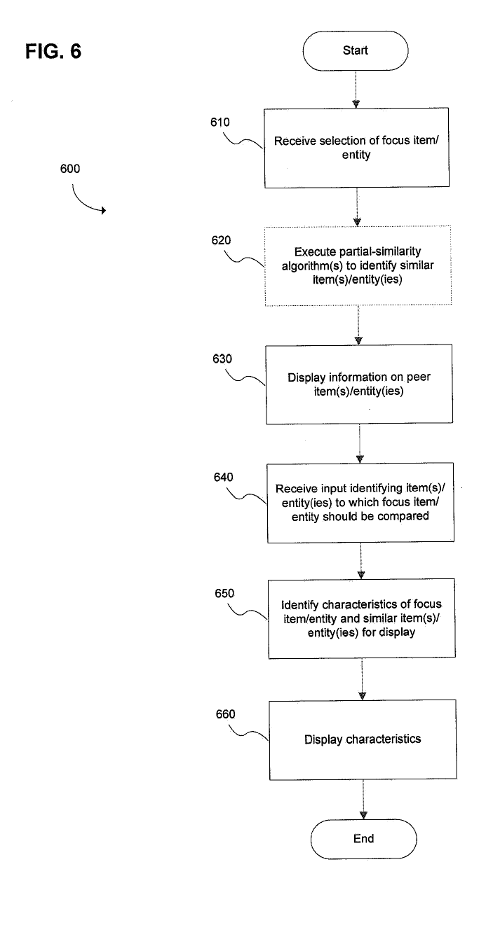

An example process 600 which may be performed to enable the types of comparisons and contrasts between a focus entity and one or more other entities is depicted in FIG. 6. Process 600 may be performed, for example, via the execution of programmed instructions on one or more computing devices, although embodiments of the invention are not so limited.

At the start of process 600, input is received defining a selection of an entity of interest in act 610. For example, input may be received from a user of a UI similar to any one or more of UIs 100-500 (e.g., in the form of a mouse click, other form of input, or combination thereof) indicating a focus entity. Of course, embodiments of the invention are not limited to employing a UI similar to those described with reference to FIGS. 1-5, as any of numerous techniques may be employed to receive input defining the selection of a focus entity. Embodiments of the invention are not limited to any particular implementation.

Upon the completion of act 610, process 600 may proceed to act 620. In this respect, act 620 is optional, and involves identifying one or more entities similar to the focus entity in one or more respects. If performed, act 620 may involve the execution of one or more partial-similarity algorithms, such as those described above with reference to FIG. 3. Of course, embodiments of the invention are not limited to identifying similar entities using via execution of a partial-similarity algorithm, as any of numerous techniques may be employed. Embodiments of the invention are not limited in this respect.

Upon the completion of act 620 (or act 610 if act 620 is not performed), process 600 proceeds to act 630, wherein information is displayed on one or more peer entities to the focus entity. If act 620 is performed, the peer entities may comprise those entities identified as being similar to the focus entity. If act 620 is not performed, the peer entities may comprise a population of entities to which the focus entity should be compared. For example, if process 600 is performed in the e-commerce context so as to enable comparison and contrast between entities of a particular type, then the peer entities may comprise all of the entities of that type except for the focus product, or some subset thereof. Any suitable technique may be employed to display information on one or more peer entities, as embodiments of the invention are not limited in this respect.

Upon the completion of act 630, process 600 proceeds to act 640, wherein input is received identifying one or more entities to which the focus entity should be compared. For example, a user of a UI similar to any one or more of UIs 100-500 may hover over or otherwise provide input to an icon or other representation of the identified entities. Of course, embodiments of the invention are not limited to employing a UI similar to those described with reference to FIGS. 1-5, as any of numerous techniques may be employed to receive input identifying entities to which a focus entity should be compared. Embodiments of the invention are not limited to any particular implementation.

Upon the completion of act 640, process 600 proceeds to act 650, wherein the attributes of the entities to be displayed is determined. For example, one or more dissimilarity algorithms may be executed to determine the attributes to be displayed.

Attributes may be chosen from a predefined set, identified as those in which dissimilarities between the entities are greatest, identified as being important to the user (e.g., based on the user's previous behavior), etc. Any of numerous techniques may be employed to determine the attributes for display, as embodiments of the invention are not limited in this respect.

Upon the completion of act 650, process 600 proceeds to act 660, wherein the determined attributes are displayed, enabling the user to examine the similarities and/or dissimilarities between the focus entity and the one or more entities identified by input received in act 640. For example, the determined attributes may be displayed on a UI similar to any one or more of UIs 100-500. Of course, embodiments of the invention are not so limited, as any of numerous techniques may be employed. Upon the completion of act 660, process 600 completes.

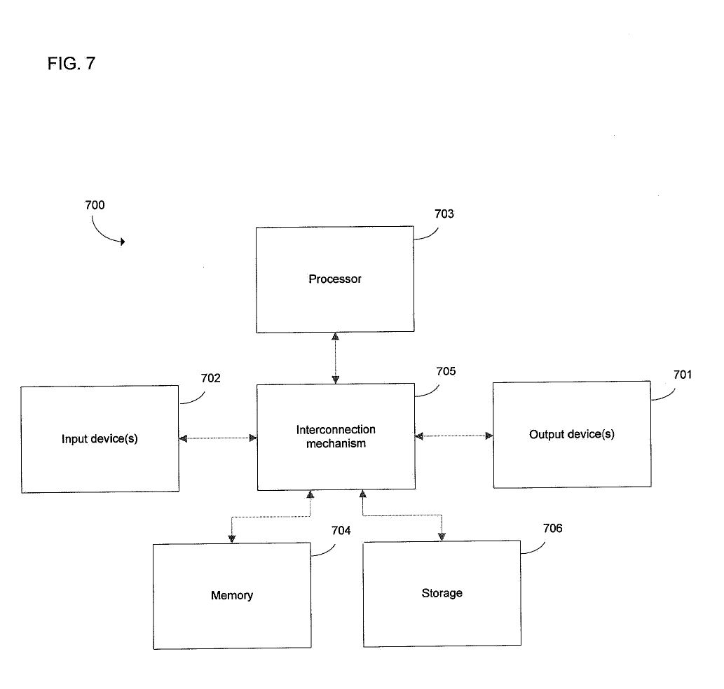

Various aspects of the systems and methods for practicing features of the invention may be implemented on one or more computer systems, such as the exemplary computer system 700 shown in FIG. 7. Computer system 700 includes input device(s) 702, output device(s) 701, processor 703, memory system 704 and storage 706, all of which are coupled, directly or indirectly, via interconnection mechanism 705, which may comprise one or more buses, switches, networks and/or any other suitable interconnection. The input device(s) 702 receive(s) input from a user or machine (e.g., a human operator), and the output device(s) 701 display(s) or transmit(s) information to a user or machine (e.g., a liquid crystal display). The processor 703 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

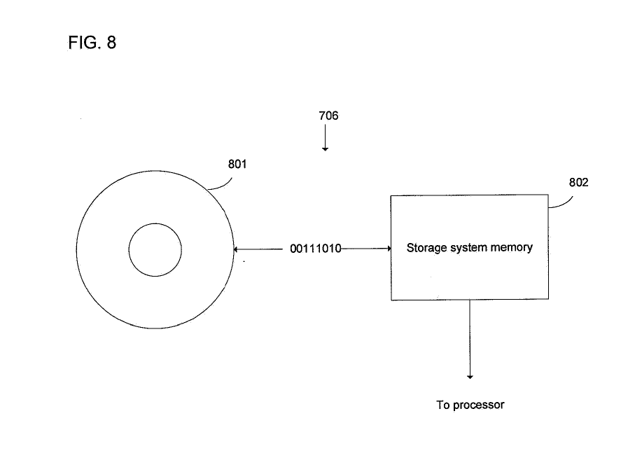

The processor 703 may also execute one or more computer programs to implement various functions. These computer programs may be written in any type of computer program language, including a procedural programming language, object-oriented programming language, macro language, or combination thereof. These computer programs may be stored in storage system 706. Storage system 706 may hold information on a volatile or non-volatile medium, and may be fixed or removable. Storage system 706 is shown in greater detail in FIG. 8.

Storage system 706 typically includes at least one computer-readable and writable non-volatile, tangible, non-transitory recording medium 801, on which signals are stored that define a computer program or information to be used by the program. An example medium may, for example, be a disk or flash memory. Typically, in operation, the processor 703 causes data to be read from the nonvolatile recording medium 801 into a volatile memory 802 (e.g., a random access memory, or RAM) that allows for faster access to the information by the processor 703 than does the medium 801. The memory 802 may be located in the storage system 706, as shown in FIG. 8, or in memory system 704, as shown in FIG. 7. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is also not limited to a particular memory system 704 or storage system 706.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for enabling a comparison between a plurality of entities of interest, each entity of interest sharing a group of attributes, each entity of interest having an attribute value for each attribute, the attribute value serving as a basis for a comparison between entities of interest, the method comprising:
(A) receiving a selection of one of the entities of interest as a focus entity;
(B) receiving an indication that one or more others of the entities of interest are to be compared to the focus entity;
(C) identifying at least one attribute of the group of attributes as defining a dissimilarity between the focus entity and the one or more of the others of the entities of interest based on the attribute values for the at least one attribute for the focus entity and the one or more of the others of the entities of interest; and
(D) outputting the identified at least one attribute for display by at least one display component.

2. The method of claim 1, wherein (A) comprises receiving the selection from the user as a first input provided to a user interface (UI) and (B) comprises receiving the indication from the user as a second input to the UI.

3. The method of claim 2, wherein (A) comprises, after receiving the selection, identifying the others of the entities of interest, and outputting for display information relating to the others of the entities of interest to the user via the UI.

4. The method of claim 3, wherein the identifying is performed via execution of at least one partial-similarity algorithm to identify the others of the entities of interest as being sufficiently similar in at least one respect to the focus entity.

5. The method of claim 3, wherein the outputting for display comprises outputting for display information relating to the others of the entities of interest organized along each of a plurality of dimensions.

6. The method of claim 2, wherein (D) comprises outputting the identified at least one attribute for display via the UI.

7. The method of claim 6, wherein (D) comprises presenting information on the focus entity and the others of the entities of interest relating to the identified at least one attribute in chart form.

8. The method of claim 1, wherein (C) comprises one or more of: (1) identifying the at least one attribute from a previously defined set of attributes, (2) identifying the at least one attribute as attribute(s) in which dissimilarities between the focus entity and the others of the entities of interest are manifested, and (3) identifying the at least one attribute as attribute(s) which previous user activity indicates is of interest to the user.

9. The method of claim 1, wherein (C) is performed via the execution of at least one dissimilarity algorithm.

10. At least one tangible computer-readable medium having instructions recorded thereon which, when executed, perform a method enabling a comparison between entities of interest, each entity of interest sharing a group of attributes, each entity of interest having an attribute value for each attribute, the attribute value serving as a basis for a comparison between entities of interest, the method comprising:
(A) receiving a selection of one of the entities of interest as a focus entity;
(B) identifying one or more others of the entities of interest to be compared to the focus entity, the identifying being performed via execution of at least one partial-similarity algorithm to identify the one or more others of the entities of interest as being sufficiently similar to the focus entity in at least one respect;
(C) receiving an indication that one or more of the others of the entities of interest are to be compared to the focus entity; and
(D) identifying at least one attribute of the group of attributes as defining a dissimilarity between the focus entity and the one or more of the others of the entities of interest based on the attribute values for the at least one attribute for the focus entity and the one or more of the others of the entities of interest, the identifying being performed via execution of at least one dissimilarity algorithm.

11. The at least one tangible computer-readable medium of claim 10, wherein the instructions define a UI presented to the user for use in performing (A)-(D).

12. The at least one tangible computer-readable medium of claim 11, wherein (A) comprises receiving the selection from the user as a first input provided to the UI and (B) comprises receiving the indication from the user as a second input to the UI.

13. The at least one tangible computer-readable medium of claim 11, wherein the method further comprises:
(E) outputting the identified at least one attribute for display via the UI.

14. The at least one tangible computer-readable medium of claim 11, wherein (E) comprises presenting information on the focus entity and the others of the entities of interest relating to the identified at least one attribute in chart form.

15. The at least one tangible computer-readable medium of claim 10, wherein (D) comprises executing the at least one dissimilarity algorithm to identify one or more of: (1) the at least one attribute from a previously defined set of attributes, (2) the at least one attribute as attribute(s) in which dissimilarities between the focus entity and the others of the entities of interest are manifested, and (3) the at least one attribute as attribute(s) which previous user activity indicates is of interest to the user.

16. A system for enabling a comparison between entities of interest, the system comprising at least one processor programmed to:
(A) receive a selection of one of the entities of interest as a focus entity;
(B) receive an indication that one or more others of the entities of interest are to be compared to the focus entity; and
(C) identify at least one attribute shared by the focus entity and the one or more others of the entities of interest as defining a dissimilarity between the focus entity and the one or more of the others of the entities of interest, the identifying being based on attribute values for the at least one attribute for the focus entity and the one or more of the others of the entities of interest.

17. The system of claim 16, wherein the at least one processor is further programmed to present a UI which receives the selection and the indication from a user.

18. The system of claim 17, wherein the at least one processor is further programmed to:
(D) output for display the identified at least one attribute to the user via the UI.

19. The system of claim 18, wherein the at least one processor is further programmed to, in (D), output for display information on the focus entity and the others of the entities of interest relating to the identified at least one attribute in chart form.

20. The system of claim 16, wherein the at least one processor is programmed to, in (C), perform one or more of: (1) identify the at least one attribute from a previously defined set of attributes, (2) identify the at least one attribute as attribute(s) in which dissimilarities between the focus entity and the others of the entities of interest are manifested, and (3) identify the at least one attribute as attribute(s) which previous activity by a user indicates is of interest to the user.
